(19) United States
(12) Patent Application Publication
(10) Pub. No.: US 2012/0109503 A1
(43) Pub. Date: May 3, 2012

(54) Li-ION BATTERY FOR VEHICLES WITH ENGINE START-STOP OPERATIONS

(75) Inventors: Jihui Yang, Lakeshore (CA); Mark W. Verbrugge, Troy, MI (US); Ping Liu, Irvine, CA (US); John S. Wang, Los Angeles, CA (US); Steven Cai, Macomb, MI (US)

(73) Assignee: GM GLOBAL TECHNOLOGY OPERATIONS, INC., Detroit, MI (US)

(21) Appl. No.: 13/170,241

(22) Filed: Jun. 28, 2011

Related U.S. Application Data
(60) Provisional application No. 61/408,020, filed on Oct. 29, 2010.

(51) Int. Cl. F02N 11/08

(52) U.S. Cl. 701/113

(57) ABSTRACT

The operation of internal combustion, reciprocating engines in some automotive vehicles may be managed such that the engine operation is stopped each time the vehicle is brought to a stop, and then the engine is re-started when the operator presses the accelerator pedal to put the vehicle in motion. In some driving situations the engine of the vehicle may be stopped and re-started many times, which is a mode of engine operation for which the traditional 12 volt, lead-acid battery is not well suited. It is found that a six cell, lithium-ion battery combining LiFePO₄ as the active positive electrode material and Li₄Ti₅O₁₂ as the active negative electrode material, together with suitable separators and a suitable low freezing point electrolyte may be adapted to deliver starting power for repeated engine starting, despite short intervening charging periods.

This application claims priority based on provisional application 61/408020, titled “Li-Ion Battery for Vehicles With Engine Start-Stop Operations,” filed Oct. 29, 2010, and which is incorporated herein by reference.

### TECHNICAL FIELD

This invention provides a lithium-ion battery, nominally of 12 volt DC capacity, capable of powering repeated reciprocating piston, internal combustion engine starting and re-starting in a vehicle for engine start-stop operation. More specifically, the battery may be characterized as having six cells, each operating at about 2 volts, and each combining a LiFePO₄ positive electrode material and a Li₄Ti₅O₁₂ negative electrode material, with a suitable low freezing point electrolyte composition.

### BACKGROUND OF THE INVENTION

Designers and manufacturers of automotive vehicles continually strive to improve the fuel economy of their gasoline fueled (or gasoline and alcohol fueled) or diesel fueled, multi-cylinder, reciprocating piston, internal combustion engine-driven vehicles. One approach for reducing fuel consumption in the operation of such vehicles is to stop engine operation each time that the vehicle comes to a complete stop (even a brief stop) and, then, to restart the engine when the operator releases the brake pedal or presses the gas pedal. Such start-stop operations of the vehicle engines are often managed (in different ways) by an electronic computer control module and sensors which react to the operator's stopping and starting commands.

In the many decades of usage of internal combustion engine powered vehicles, the starting of the vehicle engine was usually accomplished using a small starting motor powered by an electrochemical battery based on lead-lead oxide electrodes, with lead sulfate being the discharge product on each electrode, and a water-sulfuric acid electrolyte. Indeed, batteries comprising six such cells, providing 12-14 volts DC, (called starting, lighting, and ignition batteries or SLI batteries) served to power vehicles' ignition systems, lighting systems, entertainment centers, and the like, in addition to powering engine starting. Then, during periods of suitably long engine operation, an engine-powered alternator (or generator) re-charged the vehicle's lead-acid SLI battery.

Now it is found by the inventors herein that, with many systems for engine start/stop operation as a regular driving mode, the familiar lead-acid battery is not well suited for such frequent engine starting and stopping. The frequent demands for high power for engine starting and the short intervening periods for re-charging adversely affect the life and utility of lead-acid batteries.

### SUMMARY OF THE INVENTION

In vehicle start-stop modes of operation, the internal combustion engine is stopped each time the vehicle is brought to a complete standstill. The engine is then re-started when the operator releases the brake pedal, or presses the accelerator pedal, or otherwise signals the vehicle to move under engine power. Of course, such repeated stopping and starting of a vehicle engine may occur many times in the course of each trip in which a vehicle is used. Such engine operation systems have the virtue of reducing the consumption of vehicle fuel, when the engine would have been idling, and the corresponding production of emissions. But the inventors have observed that engine start-stop systems markedly alter the requirements of the SLI battery. Start-stop systems require the battery to provide high power and endure shallow discharge/re-charge cycling, and the conventional SLI lead-acid batteries are not well suited for such frequently repeated engine starting operations without suitable intervening charging times. The cycle life of the lead acid SLI batteries is significantly reduced due to the necessary high rates of operation and the associated rapid acid stratification, accelerated corrosion of the lead oxide electrode current collector, and substantial sulfation of the lead negative electrode.

The inventors have found that 12 V DC, Li-ion batteries combining LiFePO₄ (LFP) as the active positive electrode material and Li₄Ti₅O₁₂ (LTO), as the active negative electrode material, provide significantly improved cycle life, and superior power capability in engine start-stop modes of vehicle operation. LFP as the active material for positive electrode of a Li ion battery provides excellent cycle life and rate capability. The LTO as a negative electrode material has the advantages of enabling higher power (due to having lower impedance than graphite-containing electrodes), outstanding stability, long cycle life (due to near zero strain of the LTO when cycling between charged and discharged states), and excellent low temperature performance. And the combination of LFP/LTO as the electrode materials is found to provide low internal impedance, long cycle life, and stability during repeated discharge and charging cycling over short time periods as a vehicle engine is repeatedly stopped and re-started.

The LFP/LTO electrode combination is compatible with the many known lithium-containing electrolyte materials and non-aqueous solvents for these electrolyte compounds. Moreover, the LFP/LTO electrode combination, due to its reduced operating voltage window (of about two volts or so per cell) as compared to other lithium ion batteries (often based on lithium/carbon materials as the negative electrode material), raises the possibility of using electrolyte solvents such as propylene carbonate and acetonitrile of lower freezing points (e.g., for electrolyte solution operation below about −30° C.) and viscosities than the present Li-ion battery systems used for electric motor powered vehicles. Other low freezing point solvents include dimethyl carbonate, diethyl carbonate, propylonitrile, and butylonitrile. A suitable electrolyte material may be, for example, lithium hexaflurophosphate (LiPF₆), LiBF₄, lithium triflate (lithium trifluoromethane sulfonate), or LiClO₄. This change in solvents can lead to great enhancement of low temperature performance as compared to traditional lithium-ion batteries. Finally, the expected long cycle life is due to the fact that both LFP and LTO operate at potentials (3.5 and 1.5 V vs. Li/Li+, respectively) safely within the stability window of common lithium-ion battery electrolytes.

While lithium iron phosphate (LiFePO₄) is the preferred positive electrode material, additional metal ions may be included with iron in the phosphate compound composition. Thus, more broadly, a suitable positive electrode material may be LiMPO₄, where M includes iron or a combination (in the lithium and phosphate crystal structure) of iron with any one or more of magnesium, calcium, or one or more transition metals selected from the groups that include iron. For example, the transition metal may include one or more of titanium, vanadium, chromium, manganese, cobalt, nickel, copper, and zirconium, niobium, molybdenum, ruthenium, rhodium, palladium, and silver.

As stated, the operating voltage of the LFP/LTO cell is around two volts under expected operating conditions. Six of the cells will be connected in series to offer twelve volt nominal outputs in a battery for engine start-stop operations. There are two preferred embodiments when using a 12 V, Li ion LFP/LTO battery for a vehicle with engine start-stop operations. The first is just to replace the lead-acid battery with a 12 V LFP/LTO battery; while the second is to have two onboard batteries, a SLI lead acid battery to handle the accessory load and a 12 V LFP/LTO battery to be used for the high power charge/discharge requirements of start-stop vehicle engine operation.

Thus, in accordance with practices of the invention, a specific six-cell, nominally 12 volt DC, lithium-ion battery, based on LFP/LTO electrodes in each cell, is used as the sole source of energy for engine starting in a vehicle operated in an engine start/stop mode. This lithium-ion battery would be placed on-vehicle and used on each engine-start command of an engine control module to power an electric motor used to turn and start the vehicle's internal combustion engine. The lithium-ion battery would be charged by an alternator or generator specified for use on the vehicle and driven as required during engine operation. In some vehicles, the use of an internal combustion engine for driving vehicle wheels may be complemented by an electric motor and generator also coupled to the vehicle drive shaft. The lithium-ion battery of this invention may be used for start-stop mode operation of the engine in such a hybrid vehicle propulsion system.

Other objects and advantages of the invention will be apparent from a detailed description of certain illustrative embodiments which follow in this specification. Reference will be made to drawing figures described in the following paragraphs.

### BRIEF DESCRIPTION OF THE DRAWINGS

FIG. 1 is a schematic illustration, using information-containing blocks which illustrate the use of a LTO/LFP lithium-ion battery for starting an internal combustion engine in an engine start-stop operating mode and the concomitant use of a lead-acid battery for other vehicle accessory power requirements. In this illustrative example, the output of the internal combustion engine is coupled with a motor/generator system in driving the wheels of the vehicle. In this example, the motor mode of operation of the motor/generator system is used in starting the engine and the generator mode is used in charging both the LTO/LFP lithium-ion battery and the lead-acid battery. A clutch is employed to connect the IC engine and motor/generator system to the rest of the vehicle drive-train, including the transmission, differential, and vehicle wheels.

FIG. 2 is a schematic illustration of a vehicle, for engine start-stop operating mode, that is like the system illustrated in FIG. 1 except that the clutch is positioned between the IC engine and the motor/generator.

FIG. 3 is a schematic illustration, using information-containing blocks which illustrate the use of a LTO/LFP lithium-ion battery both for starting an internal combustion engine (heat engine) in an engine start-stop operating mode and for powering other vehicle accessory power requirements. In this illustrative example, the output of the heat engine is also coupled with a motor/generator system in driving the wheels of the vehicle. Again, the motor portion of the system is used in starting the IC engine and the generator portion of the system is used in charging the LTO/LFP lithium-ion battery. A clutch is employed to connect the IC engine and motor/generator system to the rest of the vehicle drive-train, including the transmission, differential, and vehicle wheels.

FIG. 4 is a schematic illustration of a vehicle, for engine start-stop operating mode, that is like the system illustrated in FIG. 3 except that the clutch is positioned between the IC engine and the motor generator.

### DESCRIPTION OF PREFERRED EMBODIMENTS

This invention uses a lithium-ion battery electrode materials combination specifically adapted for repeated starting of an internal combustion engine on a vehicle when the engine is to be operated in a start-stop mode of engine operation. Such engines typically comprise several pistons (e.g., 4, 6, or 8) connected to a crankshaft for reciprocation in cylinders of the engine. A metered charge of hydrocarbon fuel (gasoline, sometimes containing alcohol, or diesel fuel) and a controlled amount of air are introduced in a specified sequence into the cylinders of the engine. The inducted air-fuel mixture is compressed by piston action in each cylinder and ignited by a spark or by compression to drive the respective pistons and the crankshaft to which they are connected. In order to start such an engine, its crankshaft and connecting pistons must be turned using a starter motor in order to start air-fuel induction and the ignition/combustion process.

In accordance with this invention, a lithium-ion battery comprising LiMPO₄, preferably LiFePO₄, as the active positive electrode material and Li₄Ti₅O₁₂ as the active negative electrode material is employed. Each cell of such a battery will produce an electrochemical potential of about 2+ volts and six cells in electrical series connection will provide the twelve to fourteen volts direct-current potential normally sought for automotive engine starting requirements. The size of the battery cells in terms of the amounts of electrode materials is determined to provide suitable electrical current for a vehicle starting-motor (or the like) to turn the vehicle engine for initial induction of a combustible mixture into the cylinders and ignition of the mixture and engine starting.

In many embodiments of this invention, the lithium-ion battery will comprise six vertically-oriented cells arranged in electrical series connection. Each such main cell unit in series connection may comprise several cells in electrical parallel connection to collectively provide suitable power for the battery's engine starting role and any additional role in powering other of the vehicle's electrical power requirements. In each cell, negative electrode plates comprising particles of Li₄Ti₅O₁₂ active material and positive electrode plates comprising particles of LiFePO₄ active material will be physically separated by a porous separator plate. For example, a separator may be suitably formed of micro-pore containing polyolefin material (or other suitable separator material). The bodies of the respective electrode materials and interposed porous separator layer or body are wetted and infiltrated with a suitable liquid electrolyte. As stated above, a suitable electrolyte comprises lithium hexaflurophosphate dissolved in a non-aqueous solvent, such as a mixture of carbonates (ethylene carbonate plus dimethyl carbonate). But the electrode combination of this invention also permits the use of propylene carbonate and/or acetonitrile, which offer lower freezing points and lower electrolyte viscosity. Other low freezing point solvents include, for example, diethyl carbonate, propylonitrile, and butylonitrile. In many embodiments of the invention it is preferred to use a solvent for the electrolyte compound such that the electrolyte solution remains liquid at temperatures as low as −30° C.

The respective LFP and LTO electrode materials are suitably prepared in the form of fine particles mixed with a suitable compatible binder material for durable adherence as a layer or film to a suitably electrically-conductive metallic electrode plate. The electrode plates may be formed, for example, of copper or aluminum. The positive electrodes in a cell are often arranged in electrical parallel connection (as are the negative electrodes) to provide a suitable electrical current. Six cells are connected in series to accumulate and provide a specified voltage and current for engine starting and other vehicle electrical power requirements that are dependent on the lithium-ion battery. In other words, the energy-providing capacity of the battery may vary with the displacement or size of the engine to be started and re-started. And the capacity of the battery may be increased when it is used to power lighting and other systems on the vehicle.

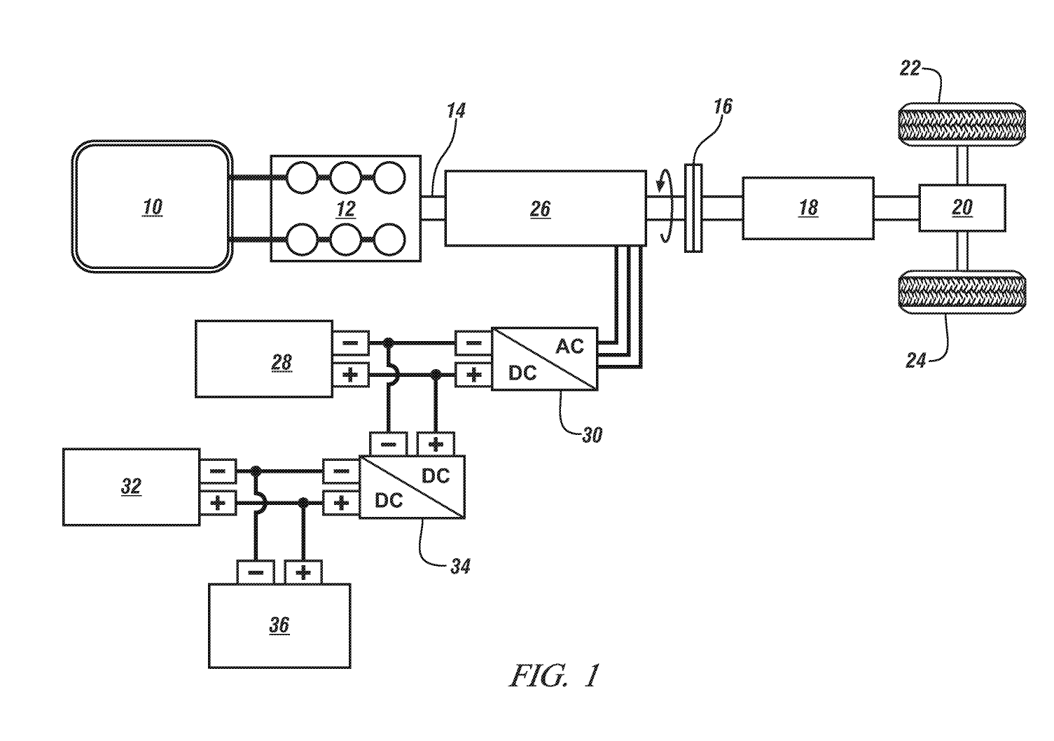

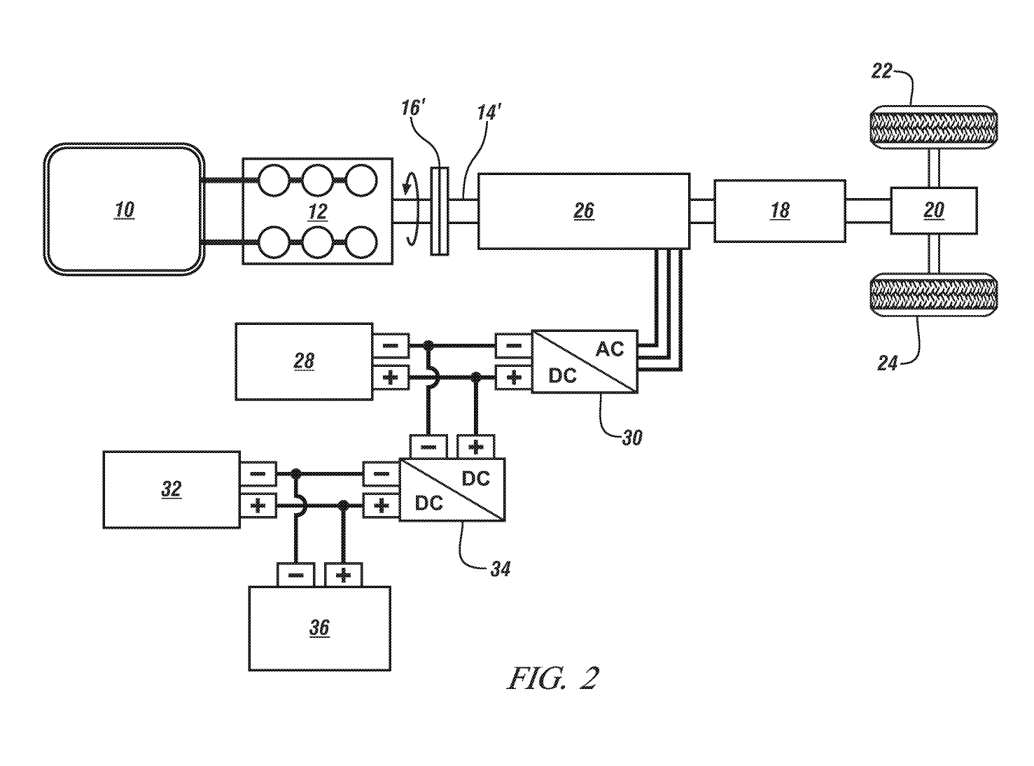

FIG. 1 illustrates, schematically, a six cylinder internal combustion heat engine 12 coupled to a suitable fuel tank and fuel delivery system 10. The crankshaft of the engine is connected to a vehicle driveshaft 14 which is connected through a suitable clutch 16 to the vehicle transmission 18. The transmission 18 is connected to a suitable differential 20 for selective delivery of engine power to two drive wheels 22, 24 of the vehicle. In this FIG. 1 (and in accompanying FIGS. 2, 3, and 4), various suitable drive train members (illustrated schematically and not further specified or numbered) may be used to suitably interconnect the engine 12, clutch 16, transmission 18, differential 20 and wheels 22, 24 in a suitable drive-train system.

In the embodiment of FIG. 1, a complementary electric motor/electric generator 26 is also coupled to the engine drive shaft 14 before the driveshaft-clutch 16 connection. In this embodiment an electric motor powered by a very high energy battery (such high energy traction battery is not shown in FIG. 1), and/or by an electric generator, may be used in a predetermined combination with the heat engine to contribute to the driving of the vehicle traction wheels. The electric motor portion of electric motor/generator 26 may be used to supplement the effort of the engine 12 or when the vehicle is moving and engine 12 is not being operated. This combination is sometimes called a hybrid vehicle mode of propulsion. The clutch 16 permits engine 12 rotation and/or electric motor operation when the vehicle is not to be moving.

A computer-based engine control module, or a combination of control modules, not shown in FIG. 1, is provided on the vehicle and programmed to manage the operation of the heat engine 12 and the operation of the motor/generator system 26. The control system manages the combustion processes in the engine 12 and the starting and stopping of the engine as well as the timing of the contributions of the motor/generator system 26.

The embodiment of FIG. 2 illustrates a similar hybrid vehicle, heat engine 10 and electric motor driving arrangement except that the motor/generator combination 26 is coupled to the engine driveshaft 14′ after the clutch 16′ (i.e., (downstream in the drive train arrangement). The other elements of the FIG. 2 illustration correspond in function to those in FIG. 1.

In FIG. 1, a LTO/LFP battery 28, a starting energy-storage device, is electrically connected through an AC/DC power inverter 30 to the motor/generator 26 and the engine driveshaft 14. When the vehicle heat engine 12 is to be started, electrical energy is drawn from the LTO/LFP battery 28 to turn and start the engine 12 through the electric motor/generator 26, operating in its motor mode, or a separate starter-motor (not shown in the drawing Figures). When the engine 12 is running, the LTO/LFP battery 28 may be electrically charged by the motor/generator system 26, operating in its generator mode, as managed by the computer control system.

The embodiment of the invention illustrated in FIG. 1 also employs a supplemental lead-acid battery, now termed a hotel-load battery 32, for electrically powering other vehicle power requirements (collectively, 36) such as the heating and cooling systems for the passenger compartment, lighting systems, entertainment systems, electronic control systems, and the like. The hotel-load battery 32 is suited for these auxiliary type power requirements and may be made smaller because it is not used for engine starting. As illustrated in FIG. 1, the motor/generator system 26 may also be electrically connected through an AC/DC power 30, and a DC/DC converter 34 to the hotel-load battery 32 and to auxiliary power loads 36 on the vehicle.

As stated above, FIG. 2 illustrates a second embodiment of the invention in which the motor/generator system 26 is coupled with the engine driveshaft 14′ downstream of the clutch 16′.

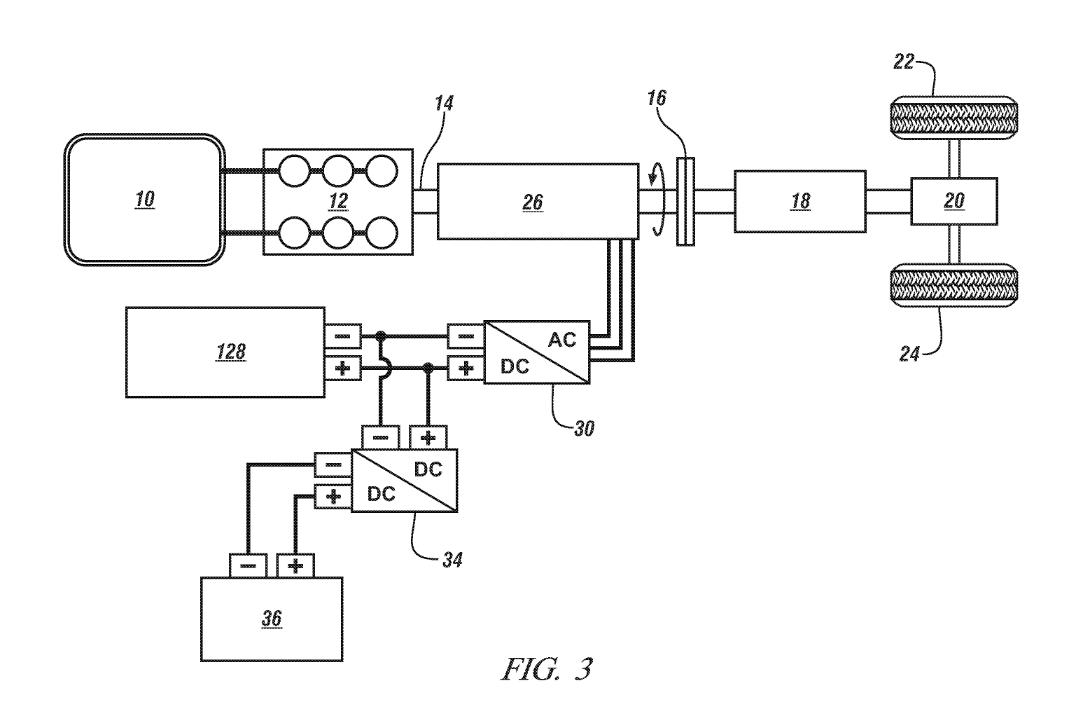

FIG. 3 illustrates an embodiment of the invention in which the LTO/LFP lithium-ion battery is employed without a supplemental hotel-load battery. The LTO/LFP battery is employed for repeated engine starting in the start-stop mode of operation. And the LTO/LFP battery, in combination with the motor/generator system, supplies accessory power loads.

In FIG. 3, a LTO/LFP battery 128 (possibly of larger capacity than battery 28 in FIGS. 1 and 2), a starting energy-storage device, is electrically connected through an AC/DC power inverter 30 to the motor/generator 26 and the engine driveshaft 14. When the vehicle heat engine 12 is to be started, electrical energy is drawn from the LTO/LFP battery 128 to turn and start the engine 12 through the electric motor/generator 26 or a separate starter-motor (not shown in the drawing Figures). When the engine 12 is running, the LTO/LFP battery 128 may be electrically charged by the motor/generator system 26 as managed by the computer control system. Alternating current electrical power from motor generator 26 is transformed to direct current in AC/DC power inverter 30. Some power from inverter 30 is used to charge LTO/LFP battery 128 and a portion may be converted in DC/DC power inverter 34 to provide power for auxiliary power loads 36 on the vehicle.

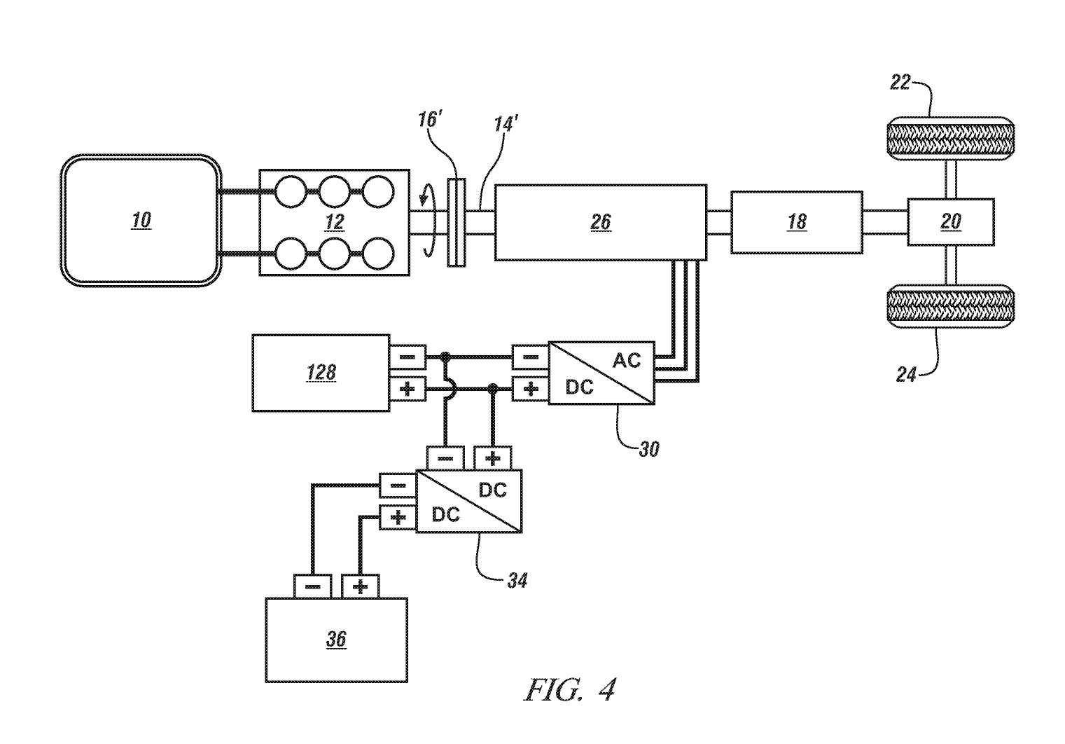

FIG. 4 illustrates still another embodiment of the invention in which the motor/generator system 26 is coupled with the engine driveshaft 14′ downstream of the clutch 16′.

In the embodiments of the invention illustrated in FIGS. 1-4, the LTO/LFP lithium-ion battery was used for engine starting and accessory power loads on hybrid vehicle propulsion systems using a combination of a heat engine and an electric motor/generator set. However, it is apparent that the LTO/LFP lithium-ion battery may also be used on vehicles that are powered exclusively with an internal combustion engine which is operated in a start-stop mode. And in these engine-powered vehicles, the LTO/LFP lithium-ion battery may be used alone or in combination with a lead-acid battery, where the lithium-ion battery is used for engine starting and the hotel-load battery is used for lighting, passenger comfort, and entertainment and other vehicle power requirements.

Practices of the invention are not limited to the illustrative embodiments.

1. An automotive vehicle comprising a reciprocating piston, internal combustion engine, a computer based engine control system programmed to stop the engine when the operator brings the vehicle to a stop and to re-start the engine when the operator seeks to set the vehicle in motion, an electrically powered motor for starting the engine, and a lithium-ion battery for powering the motor and the starting of the engine; the lithium-ion battery comprising a plurality of electrochemical cells, each cell having a positive electrode material consisting essentially of lithium iron phosphate (LiMPO₄) and a negative electrode material consisting essentially of lithium titanate (Li₄Ti₅O₁₂), where M in LiMPO₄ is iron or iron and one or more elements selected from the group consisting of calcium, magnesium, and a transition metal.

2. An automotive vehicle as recited in claim 1 in which each electrochemical cell of the lithium-ion battery is composed to produce a nominal voltage of 2+ volts DC and the lithium-ion battery comprises six cells arranged and composed to produce about twelve to fourteen volts DC.

3. An automotive vehicle as recited in claim 1 in which each cell of the lithium-ion battery comprises a lithium-containing electrolyte dissolved in a non-aqueous solvent.

4. An automotive vehicle as recited in claim 3 in which each cell of the lithium-ion battery comprises an electrolyte selected from the group consisting of LiPF₆, LiBF₄, lithium triflate, and LiClO₄, and the electrolyte is dissolved in a solvent consisting of one or more of dimethyl carbonate, diethyl carbonate, propylene carbonate, acetonitrile, propylonitrile, and butylonitrile.

5. An automotive vehicle as recited in claim 3 in which each cell of the lithium-ion battery comprises an electrolyte selected from the group consisting of LiPF₆, LiBF₄, lithium triflate, and LiClO₄.

6. An automotive vehicle as recited in claim 3 in which each cell of the lithium-ion battery comprises an electrolyte dissolved in a solvent consisting of one or more of dimethyl carbonate, diethyl carbonate, propylene carbonate, acetonitrile, propylonitrile, and butylonitrile.

7. An automotive vehicle as recited in claim 1 the vehicle further comprising a lead-acid type battery and such that engine starting is accomplished using only the lithium-ion battery and the lead-acid type battery is used to power other vehicle electrical requirements.

8. An automotive vehicle comprising a reciprocating piston, internal combustion engine, a computer based engine control system programmed to stop the engine when the operator brings the vehicle to a stop and to re-start the engine when the operator seeks to set the vehicle in motion, an electrically powered motor for starting the engine, and a lithium-ion battery for powering the starting of the engine; the lithium-ion battery comprising a plurality of electrochemical cells, each cell having a positive electrode material consisting essentially of lithium iron phosphate (LiFePO₄) and a negative electrode material consisting essentially of lithium titanate (Li₄Ti₅O₁₂), the lithium-ion battery further comprising a lithium-containing electrolyte dissolved in a non-aqueous liquid solvent, the electrolyte solution having a freezing point below about −30° C.

9. An automotive vehicle as recited in claim 1 where M in the LiMPO₄ positive electrode material is iron or iron and one or more elements selected from the group consisting of calcium, magnesium, titanium, vanadium, chromium, manganese, cobalt, nickel, copper, and zirconium, niobium, molybdenum, ruthenium, rhodium, palladium, and silver.

10. A method of operating an automotive vehicle comprising a reciprocating piston, internal combustion engine, a computer based engine control system programmed to stop the engine when the operator brings the vehicle to a stop and to re-start the engine when the operator seeks to set the vehicle in motion, and an electrically powered motor for starting the engine; the method comprising;
powering the starting of the engine using a lithium-ion battery; the lithium-ion battery comprising a plurality of electrochemical cells, each cell having a positive electrode material consisting essentially of lithium metal phosphate (LiMPO₄) and a negative electrode material consisting essentially of lithium titanate (Li₄Ti₅O₁₂), where M in LiMPO₄ positive electrode material is iron or iron and one or more elements selected from the group consisting of calcium, magnesium, and a transition metal.

11. A method of operating an automotive vehicle as recited in claim 10 in which each electrochemical cell of the lithium-ion battery is composed to produce a nominal voltage of 2+ volts DC and the lithium-ion battery comprises six cells arranged and composed to produce about twelve to fourteen volts DC.

12. A method of operating an automotive vehicle as recited in claim 10 in which each cell of the lithium-ion battery comprises an electrolyte dissolved in a non-aqueous solvent.

13. A method of operating an automotive vehicles as recited in claim 10 in which each cell of the lithium-ion battery comprises a lithium-containing electrolyte, the electrolyte being selected from the group consisting of LiPF₆, LiBF₄, lithium triflate, and LiClO₄

14. A method of operating an automotive vehicle as recited in claim 10 in which each cell of the lithium-ion battery comprises an electrolyte dissolved in one or more of dimethyl carbonate, diethyl carbonate, propylene carbonate, acetonitrile, propylonitrile, and butylonitrile.

15. A method of operating an automotive vehicle as recited in claim 10 in which each cell of the lithium-ion battery comprises an electrolyte selected from the group consisting of LiPF₆, LiBF₄, lithium triflate, and LiClO₄, and the electrolyte is dissolved in a solvent consisting of one or more of dimethyl carbonate, diethyl carbonate, propylene carbonate, acetonitrile, propylonitrile, and butylonitrile.

16. A method of operating an automotive vehicle as recited in claim 10 in which a lead-acid type battery is used to power vehicle electrical components and that engine starting is accomplished using only the lithium-ion battery.

17. A method as recited in claim 10 where M in the LiMPO₄ positive electrode material is iron or iron and one or more elements of a transition metal selected from the group consisting of calcium, magnesium, titanium, vanadium, chromium, manganese, cobalt, nickel, copper, and zirconium, niobium, molybdenum, ruthenium, rhodium, palladium, and silver.

18. A method of operating an automotive vehicle as recited in claim 10 in which each cell of the lithium-ion battery comprises an electrolyte dissolved in a non-aqueous solvent, the electrolyte solution having a freezing point below minus 30° C.
